(19) United States
(12) Patent Application Publication
(10) Pub. No.: US 2018/0311929 A1
(43) Pub. Date: Nov. 1, 2018

(54) MULTI-LAYER ASSEMBLIES WITH ONE OR MORE MESH LAYERS

(71) Applicants: Mark John Mason, Highland, MI (US); John Christian, Fenton, MI (US); Anthony Joseph Messina, Macomb Township, MI (US)

(72) Inventors: Mark John Mason, Highland, MI (US); John Christian, Fenton, MI (US); Anthony Joseph Messina, Macomb Township, MI (US)

(21) Appl. No.: 15/924,968

(22) Filed: Mar. 19, 2018

Related U.S. Application Data
(60) Provisional application No. 62/473,048, filed on Mar. 17, 2017.

(51) Int. Cl. B32B 5/02; B32B 5/24; B32B 5/26

(52) U.S. Cl. CPC B32B 5/028; B32B 5/245; B32B 2260/046; B32B 2605/00; B32B 5/26

(57) ABSTRACT

Certain configurations of a multi-layer assembly comprising a mesh layer and a first thermoplastic fiber reinforced thermoplastic layer disposed on a first surface of mesh layer are described. In some examples, the multi-layer assembly comprises two fiber reinforced thermoplastic layers coupled to each other through a mesh layer. Articles comprising a multi-layer assembly and methods of producing a multi-layer assembly are also described.

### PRIORITY APPLICATION

This application is related to and claims priority to and the benefit of, U.S. Provisional Application No. 62/473,048 filed on Mar. 17, 2017, the entire disclosure of which is hereby incorporated herein by reference for all purposes.

### TECHNOLOGICAL FIELD

This application is related to reinforced thermoplastic composites and their use in vehicles and/or in the building industry. More particularly, certain configurations described herein are related to a mesh layer in combination with one or more thermoplastic fiber reinforced layers.

### BACKGROUND

Automotive vehicles are typically produced using steel materials or other materials that to provide strength and/or structural reinforcement. The inclusion of steel materials can increase the overall weight of the automotive vehicles, which can reduce fuel mileage and increase operating costs.

### SUMMARY

Certain aspects, embodiments, configurations and examples are described below of multi-layer assemblies comprising one or more mesh layers and one or more thermoplastic fiber reinforced layers.

In one aspect, a multi-layer assembly comprises a mesh layer and a first fiber reinforced thermoplastic layer. In some examples, the mesh layer comprises reinforcing fibers held in place by a thermoplastic material, e.g., the mesh layer may comprise a substantially non-porous tape layer or tape layers. In certain examples, the first fiber reinforced thermoplastic layer is disposed on a first surface of mesh layer. The first fiber reinforced thermoplastic layer may comprise a web of open celled structures formed by a plurality of reinforcing materials bonded together with a thermoplastic material, e.g., the fiber reinforced thermoplastic layer may be configured as a porous layer that can couple directly to the mesh layer.

In certain examples, the first reinforced thermoplastic layer is directly coupled to the mesh layer without any intervening layers or materials. In other examples, the multi-layer assembly comprises a second reinforced thermoplastic layer disposed on a second surface of mesh layer, where the second fiber reinforced thermoplastic layer comprises a web of open celled structures formed by a plurality of reinforcing materials bonded together with a thermoplastic material. In some examples, the second reinforced thermoplastic layer is directly coupled to the mesh layer without any intervening layers or materials.

In other instances, the multi-layer assembly comprises a first skin layer disposed on the first reinforced thermoplastic layer. In some examples, the multi-layer assembly comprises a second skin layer disposed on the second reinforced thermoplastic layer.

In certain examples, the mesh layer comprises glass fibers and polypropylene and is configured as a woven tape layer, and the first fiber reinforced thermoplastic layer and the second fiber reinforced thermoplastic layer each comprises polypropylene and glass fibers and a basis weight of about 800 gsm to about 1000 gsm.

In some embodiments, the multi-layer assembly comprises a decorative layer coupled to one of the first fiber reinforced thermoplastic layer and the second fiber reinforced thermoplastic layer. In other examples, the decorative layer comprises a foam bonded to a fabric.

In some instances, the thermoplastic material of the first fiber reinforced thermoplastic layer comprises one or more of polyethylene, polypropylene, polystyrene, acrylonitrylstyrene, butadiene, polyethyleneterephthalate, polybutyleneterephthalate, polybutylenetetrachlorate, polyvinyl chloride, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, a poly(1,4 phenylene) compound, a high heat polycarbonate, high temperature nylon, silicones, or blends of these materials with each other.

In certain examples, the reinforcing fibers of the first fiber reinforced thermoplastic layer comprise one or more of glass fibers, aramid fibers, graphite fibers, carbon fibers, inorganic mineral fibers, metal fibers, metalized synthetic fibers, and metallized inorganic fibers, fibers or combinations thereof.

In some configurations, the multi-layer assembly comprises a skin coupled to a surface of the first fiber reinforced thermoplastic layer. In certain examples, the skin is selected from the group consisting of a thermoplastic film, an elastomeric film, a frim, a scrim, a foil, a woven fabric, a non-woven fabric, a fiber scrim or be present as an inorganic coating, an organic coating, a thermoplastic coating and a thermoset coating.

In some examples, the first fiber reinforced thermoplastic layer further comprises a lofting agent.

In other examples, the multi-layer assembly comprises a decorative layer coupled to the first fiber reinforced thermoplastic layer.

In another aspect, a multi-layer assembly comprises a mesh layer, a first fiber reinforced thermoplastic layer, and a second fiber reinforced thermoplastic layer. The mesh layer may comprise a first tape layer and a second tape layer, wherein the first and second tape layers are present in a woven arrangement, and wherein each of the first tape layer and the second tape layer comprises reinforcing fibers held in place by a thermoplastic material. The first fiber reinforced thermoplastic layer can be disposed on a first surface of mesh layer. The first fiber reinforced thermoplastic layer comprises a web of open celled structures formed by a plurality of reinforcing materials bonded together with a thermoplastic material. The second fiber reinforced thermoplastic layer can be disposed on a second surface of mesh layer. The second fiber reinforced thermoplastic layer comprises a web of open celled structures formed by a plurality of reinforcing materials bonded together with a thermoplastic material. Each of the first fiber reinforced thermoplastic layer and the second fiber reinforced thermoplastic layer can be directly coupled to the mesh layer without any intervening layer or material.

In certain examples, the multi-layer assembly comprises a second mesh layer disposed on a surface of the second fiber reinforced thermoplastic layer.

In some examples, the thermoplastic material of the first fiber reinforced layer is different than the thermoplastic material of the second fiber reinforced layer. In other examples, the thermoplastic material of the first fiber reinforced layer comprises a common material as the thermoplastic material of the second fiber reinforced layer. In certain instances, the thermoplastic material of the first fiber reinforced layer and the thermoplastic material of the second fiber reinforced layer each comprises polypropylene. In some examples, the reinforcing fibers of the first fiber reinforced layer are different than the reinforcing fibers of the second fiber reinforced layer. In other examples, the reinforcing fibers of the first fiber reinforced layer comprises a common material as the reinforcing fibers of the second fiber reinforced layer. In some embodiments, the reinforcing fibers of the first fiber reinforced layer and the reinforcing fibers of the second fiber reinforced layer comprise glass fibers.

In some examples, the multi-layer assembly comprises a first skin disposed on the first reinforced thermoplastic layer. In some configurations, the skin is selected from the group consisting of a thermoplastic film, an elastomeric film, a frim, a scrim, a foil, a woven fabric, a non-woven fabric, a fiber scrim or be present as an inorganic coating, an organic coating, a thermoplastic coating or a thermoset coating. In other examples, the multi-layer assembly comprises a second skin disposed on the second reinforced thermoplastic layer.

In certain examples, the mesh layer comprises glass fibers and polypropylene, and wherein the first fiber reinforced thermoplastic layer and the second fiber reinforced thermoplastic layer each comprises polypropylene and glass fibers and a basis weight of about 800 gsm to about 1000 gsm.

In certain configurations, the thermoplastic material of the first fiber reinforced thermoplastic layer and the thermoplastic material of the second fiber reinforced thermoplastic layer independently comprises one or more of polyethylene, polypropylene, polystyrene, acrylonitrylstyrene, butadiene, polyethyleneterephthalate, polybutyleneterephthalate, polybutylenetetrachlorate, polyvinyl chloride, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, a poly(1,4 phenylene) compound, a high heat polycarbonate, high temperature nylon, silicones, or blends of these materials with each other, and wherein the reinforcing fibers of the first fiber reinforced thermoplastic layer and the reinforcing fibers of the second fiber reinforced thermoplastic layer independently comprise one or more of glass fibers, aramid fibers, graphite fibers, carbon fibers, inorganic mineral fibers, metal fibers, metalized synthetic fibers, and metallized inorganic fibers, fibers or combinations thereof.

In some examples, the first fiber reinforced thermoplastic layer and the second fiber reinforced thermoplastic layer each further comprises a lofting agent.

In other examples, the multi-layer assembly comprises a decorative layer coupled to the first fiber reinforced thermoplastic layer or the second fiber reinforced thermoplastic layer or both.

In an additional aspect, a bulk head wall configured to separate a passenger compartment of a vehicle from a cargo compartment of the vehicle is described. In some configurations, the bulk head wall comprises a mesh layer comprising reinforcing fibers held in place by a thermoplastic material, a first fiber reinforced thermoplastic layer disposed on a first surface of mesh layer, the first fiber reinforced thermoplastic layer comprising a web of open celled structures formed by a plurality of reinforcing materials bonded together with a thermoplastic material, and a second fiber reinforced thermoplastic layer disposed on a second surface of mesh layer, the second fiber reinforced thermoplastic layer comprising a web of open celled structures formed by a plurality of reinforcing materials bonded together with a thermoplastic material.

In some examples, the bulk head wall comprises an opening between the passenger compartment and the cargo compartment.

In certain examples of the bulk head wall, the first reinforced thermoplastic layer is directly coupled to the mesh layer without any intervening layers or materials. In some instances, the mesh layer comprises glass fibers and polypropylene and is configured as a woven tape layer, and wherein the first fiber reinforced thermoplastic layer and the second fiber reinforced thermoplastic layer each comprises polypropylene and glass fibers and a basis weight of about 800 gsm to about 1000 gsm.

In other examples, the bulk head wall further comprises a decorative layer coupled to one of the first fiber reinforced thermoplastic layer and the second fiber reinforced thermoplastic layer.

In certain examples, the thermoplastic material of the first fiber reinforced thermoplastic layer and the second fiber reinforced thermoplastic layer each independently comprises one or more of polyethylene, polypropylene, polystyrene, acrylonitrylstyrene, butadiene, polyethyleneterephthalate, polybutyleneterephthalate, polybutylenetetrachlorate, polyvinyl chloride, polyarylene ethers, polycarbonates, polyestercarbonates, thermoplastic polyesters, polyimides, polyetherimides, polyamides, acrylonitrile-butylacrylate- styrene polymers, amorphous nylon, polyarylene ether ketone, polyphenylene sulfide, polyaryl sulfone, polyether sulfone, liquid crystalline polymers, a poly(1,4 phenylene) compound, a high heat polycarbonate, high temperature nylon, silicones, or blends of these materials with each other. In some examples, the reinforcing fibers of the first fiber reinforced thermoplastic layer and the reinforcing fibers of the second fiber reinforced thermoplastic layer each independently comprises one or more of glass fibers, aramid fibers, graphite fibers, carbon fibers, inorganic mineral fibers, metal fibers, metalized synthetic fibers, and metallized inorganic fibers, fibers or combinations thereof.

In certain instances, the bulk head wall further comprises a skin coupled to a surface of the first fiber reinforced thermoplastic layer. In some examples, the skin is selected from the group consisting of a thermoplastic film, an elastomeric film, a frim, a scrim, a foil, a woven fabric, a non-woven fabric, a fiber scrim or be present as an inorganic coating, an organic coating, a thermoplastic coating or a thermoset coating. In other examples, the bulk head wall comprises a skin coupled to a surface of the second fiber reinforced thermoplastic layer.

In another aspect, a vehicle comprises a passenger area and a cargo area separated by a wall panel. In some configurations, the wall panel comprises a mesh layer comprising reinforcing fibers held in place by a thermoplastic material, a first fiber reinforced thermoplastic layer disposed on a first surface of mesh layer, the first fiber reinforced thermoplastic layer comprising a web of open celled structures formed by a plurality of reinforcing materials bonded together with a thermoplastic material, and a second fiber reinforced thermoplastic layer disposed on a second surface of mesh layer, the second fiber reinforced thermoplastic layer comprising a web of open celled structures formed by a plurality of reinforcing materials bonded together with a thermoplastic material.

In certain examples, the wall panel of the vehicle comprises an opening between the passenger area and the cargo area. In other examples of the wall panel of the vehicle, the first reinforced thermoplastic layer is directly coupled to the mesh layer without any intervening layers or materials.

In some examples of the wall panel of the vehicle, the mesh layer comprises glass fibers and polypropylene and is configured as a woven tape layer, and wherein the first fiber reinforced thermoplastic layer and the second fiber reinforced thermoplastic layer each comprises polypropylene and glass fibers and a basis weight of about 800 gsm to about 1000 gsm.

In additional examples, the wall panel of the vehicle further comprises a decorative layer coupled to one of the first fiber reinforced thermoplastic layer and the second fiber reinforced thermoplastic layer.

In some embodiments, the thermoplastic material of the first fiber reinforced thermoplastic layer and the second fiber reinforced thermoplastic layer each independently comprises one or more of polyethylene, polypropylene, polystyrene, acrylonitrylstyrene, butadiene, polyethyleneterephthalate, polybutyleneterephthalate, polybutylenetetrachlorate, polyvinyl chloride, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, a poly(1,4 phenylene) compound, a high heat polycarbonate, high temperature nylon, silicones, or blends of these materials with each other.

In certain examples, the reinforcing fibers of the first fiber reinforced thermoplastic layer and the reinforcing fibers of the second fiber reinforced thermoplastic layer each independently comprises one or more of glass fibers, aramid fibers, graphite fibers, carbon fibers, inorganic mineral fibers, metal fibers, metalized synthetic fibers, and metallized inorganic fibers, fibers or combinations thereof.

In other examples, the wall panel of the vehicle further comprises a skin coupled to a surface of the first fiber reinforced thermoplastic layer. In some embodiments, the skin is selected from the group consisting of a thermoplastic film, an elastomeric film, a frim, a scrim, a foil, a woven fabric, a non-woven fabric, a fiber scrim or be present as an inorganic coating, an organic coating, a thermoplastic coating or a thermoset coating. In other examples, the wall panel of the vehicle further comprises a skin coupled to a surface of the second fiber reinforced thermoplastic layer.

In another aspect, a method of producing a multi-layer assembly comprises forming a first fiber reinforced thermoplastic layer by adding reinforcing fibers and a first thermoplastic material to an agitated liquid-containing foam to form a dispersed mixture of first thermoplastic material and reinforcing fibers, depositing the dispersed mixture of reinforcing fibers and first thermoplastic material onto a forming support element, evacuating the liquid to form a web, heating the web above the softening temperature of the first thermoplastic material, and compressing the heated web to a predetermined thickness to form the first fiber reinforced thermoplastic layer. The method may also comprise disposing a mesh layer on a first surface of the formed first fiber reinforced thermoplastic layer to provide the multi-layer assembly. For example, the mesh layer may comprise fibers and a thermoplastic material.

In certain examples, the method comprises forming a second fiber reinforced thermoplastic layer by adding reinforcing fibers and a second thermoplastic material to an agitated liquid-containing foam to form a dispersed mixture of second thermoplastic material and reinforcing fibers, depositing the dispersed mixture of reinforcing fibers and second thermoplastic material onto a forming support element, evacuating the liquid to form a web, heating the web above the softening temperature of the second thermoplastic material, compressing the heated web to a predetermined thickness to form the second fiber reinforced thermoplastic layer. The method may also comprise disposing the formed second fiber reinforced thermoplastic layer on the mesh layer.

In some examples, the first thermoplastic material and the second thermoplastic material comprise a common material.

In other examples, the method comprises forming the mesh layer by weaving two or more tape layers together, wherein each tape layer comprises the fibers and the thermoplastic material.

In some instances, the method comprises sizing the mesh layer to contact substantially all of the first surface of the first fiber reinforced layer. In other examples, the method comprises sizing the mesh layer to be smaller than the first surface of the first fiber reinforced layer.

In other examples, the method comprises configuring the first thermoplastic material to comprise a polypropylene, configuring the reinforcing fibers to comprise glass fibers and configuring the mesh layer to comprise polypropylene and glass fibers.

In some examples, the method comprises coupling a skin to the first fiber reinforced thermoplastic layer. In certain embodiments, the method comprises selecting the skin to be a thermoplastic film, an elastomeric film, a frim, a scrim, a foil, a woven fabric, a non-woven fabric, a fiber scrim or be present as an inorganic coating, an organic coating, a thermoplastic coating or a thermoset coating. In other examples, the method comprises selecting the skin to be a decorative layer.

### BRIEF DESCRIPTION OF THE SEVERAL VIEWS OF THE DRAWINGS

Certain embodiments are described with reference to the accompanying figures in which:

FIG. 1A is an illustration of a multi-layer assembly comprising a thermoplastic fiber reinforced layer and a mesh layer, in accordance with certain examples;

FIG. 1B is an illustration of a multi-layer assembly comprising a thermoplastic fiber reinforced layer, a mesh layer and a surface layer, in accordance with certain examples;

FIG. 1C is an illustration of a multi-layer assembly comprising two thermoplastic fiber reinforced layers and a mesh layer, in accordance with certain examples;

FIG. 1D is an illustration of a multi-layer assembly comprising two a thermoplastic fiber reinforced layers, a surface layer and a mesh layer, in accordance with certain examples;

FIG. 1E is an illustration of a multi-layer assembly comprising two thermoplastic fiber reinforced layers, two surface layers and a mesh layer, in accordance with certain examples;

FIG. 2 is an illustration of a multi-layer assembly comprising a thermoplastic fiber reinforced layer and two mesh layers, in accordance with some examples;

FIG. 3 is an illustration of a multi-layer assembly comprising a thermoplastic fiber reinforced layer, a mesh layer and a surface layer coupled to the mesh layer, in accordance with some examples;

FIG. 4 is an illustration of a multi-layer assembly comprising a thermoplastic fiber reinforced layer an two mesh layers coupled to each other, in accordance with some examples;

FIG. 5 is an illustration of a multi-layer assembly comprising two thermoplastic fiber reinforced layers separated by a mesh layer and a skin layer on one surface of the two thermoplastic fiber reinforced layers, in accordance with some examples;

FIGS. 6A, 6B and 6C are illustrations of a bulk head wall, in accordance with some examples;

FIGS. 7A and 7B are illustrations of a multi-layer assembly comprising a tape mesh layer disposed on a thermoplastic fiber reinforced layer, in accordance with certain embodiments; and

FIG. 8 is an illustration of tape layers that have been woven together to form a mesh layer that is disposed on a thermoplastic fiber reinforced layer, in accordance with certain embodiments.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular thickness, width or length is intended by the depictions in the figures, and relative sizes of the figure components are not intended to limit the sizes of any of the components in the figures. Where dimensions or values are specified in the description below, the dimensions or values are provided for illustrative purposes only. In addition, no particular material or arrangement is intended to be required by virtue of shading of certain portions of the figures, and even though different components in the figures may include shading for purposes of distinction, the different components can include the same or similar materials, if desired.

### DETAILED DESCRIPTION

Certain embodiments are described below with reference to singular and plural terms in order to provide a more user friendly description of the technology disclosed herein. These terms are used for convenience purposes only and are not intended to limit the layers, assemblies, articles, methods and other subject matter as including or excluding certain features unless otherwise noted as being present in a particular embodiment or excluded from a particular embodiment described herein.

In certain instances, the materials described herein can be used together to provide sheets, panels, floor pans, load floors, vehicle walls, divider panels, vehicle bulk heads, ceilings or floors, e.g., recreational vehicles walls, ceiling or floors and other articles. For example, the multi-layer assembly can be used as a wall or ceiling panel, as flooring, a sub-floor or in automotive applications such as, for example, vehicle load floors or underbody floors of a vehicle. In some examples, the multi-layer assembly can be used as a bulk head to separate a passenger compartment of a vehicle from another area of a vehicle. In other examples, the assemblies can be used in building applications such as sheathing, roofing, flooring, wall panels or the like. The use of the multi-layer assemblies described herein can provide desirable attributes including, for example, weight reduction and an increase in impact resistance.

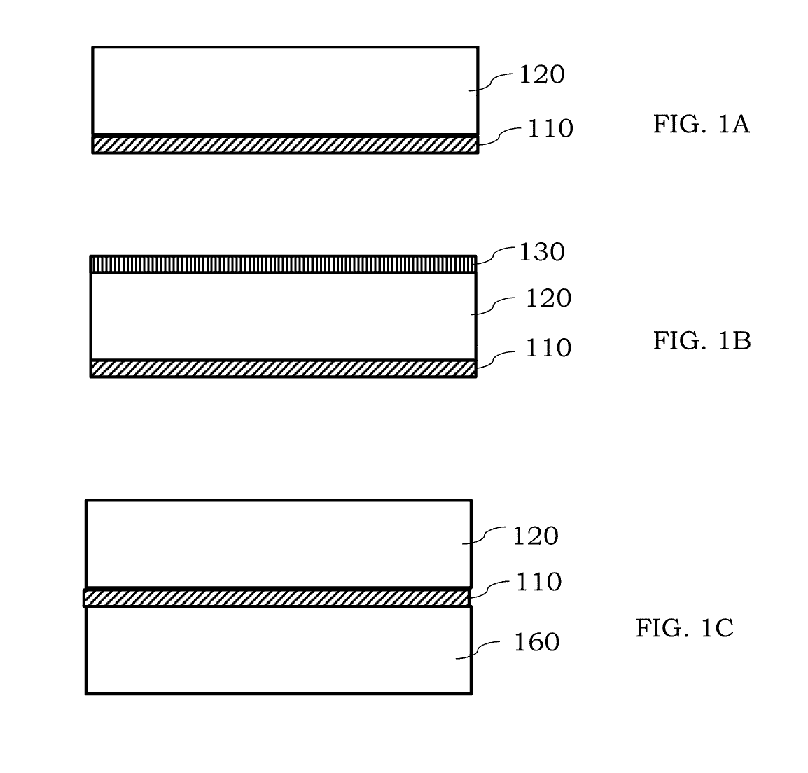

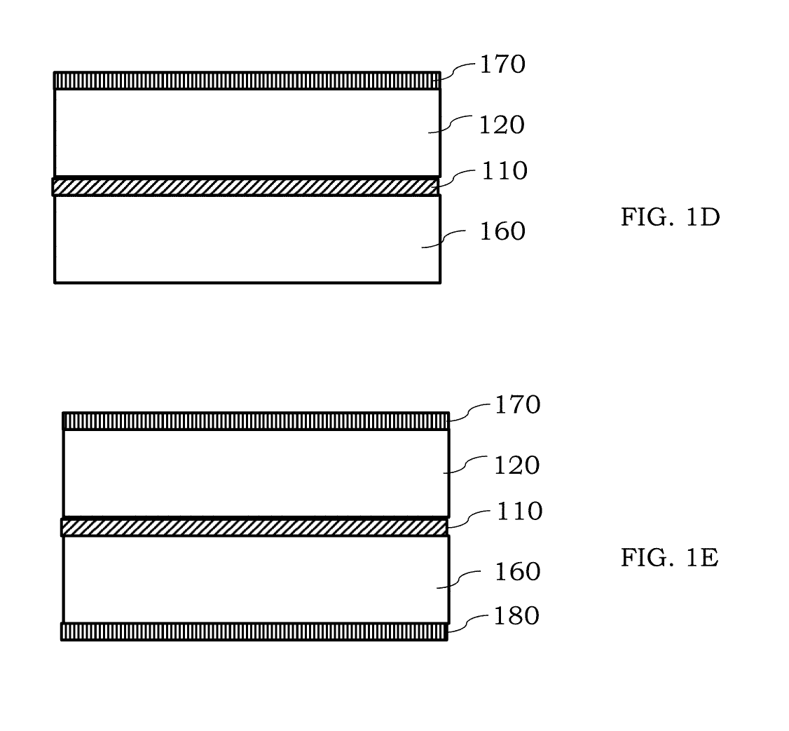

In some examples, the multi-layer assemblies described herein may comprise one or more thermoplastic fiber reinforced layers coupled to a mesh layer. The term thermoplastic fiber reinforced (TFR) layer is used interchangeably herein with the term “fiber reinforced thermoplastic layer.” If desired, the thermoplastic fiber reinforced layer can be directly coupled to the mesh layer without any intervening components or layers, e.g., without the use of an adhesive layer or other layer between the mesh layer and the thermoplastic fiber reinforced layer. FIG. 1A shows a multi-layer assembly comprising a thermoplastic fiber reinforced (TFR) layer 120 and a mesh layer 110. As noted herein, thermoplastic fiber reinforced layer 120 can be directly coupled to the mesh layer 110 without any intervening components or layers, and the properties of the mesh layer 110 can be selected such that the mesh layer and reinforced layer 120 adhere to each other at least to some degree. If desired, however, an adhesive layer or other material can be present between the layer 110 and the layer 120.

In some embodiments, the mesh layer 110 may generally comprise an arrangement of fibers and optionally one or more thermoplastic materials such as, for example, a polyolefin material. In certain instances, the mesh layer 110 may comprise an arrangement of thermoplastic fibers optionally in combination with one or more non-thermoplastic fibers, e.g., glass fibers, carbon fibers, etc. In some configurations, the mesh layer 110 may comprise an arrangement of polyolefin fibers optionally in combination with one or more non-thermoplastic fibers. For example, polyethylene fibers or polypropylene fibers or both can be present in combination with glass fibers in the mesh layer 110. If desired, one or more thermoplastic materials may also be present in combination with the thermoplastic fibers and/or any non-thermoplastic fibers. In some examples, the fibers of the mesh layer may be arranged in a non-woven pattern, a woven pattern or other patterns. In some examples, the fibers of the mesh layer may be arranged so they interest or cross over in the mesh layer. In other examples, the fibers or certain areas of the fibers may be arranged so they do not intersect or overlap in some areas. Without wishing to be bound by any one configuration, the mesh layer 110 can act as a coupling layer to permit coupling of the TFR layer 120 to another layer or structure. In some instances, the mesh layer 110 is effective to couple the TFR layer 120 to another layer without the use of any adhesive. If desired, however, an adhesive layer or material can be present between the TFR layer 120 and the mesh layer 110 or can be added on top of the mesh layer 110.

In certain configurations, the exact thickness of the mesh layer may vary and may comprise a lower thickness and/or basis weight than the thickness or basis weight of the thermoplastic reinforced fiber layers or a similar thickness and/or basis weight than the thickness or basis weight of the thermoplastic reinforced fiber layers or even a higher thickness and/or basis weight than the thickness or basis weight of the thermoplastic reinforced fiber layers. In some examples, the mesh layer 110 may be configured as a strip or tape layer with a selected number of tapes per 10 cm in length and width. For example, 1-6 tapes per 10 cm in length (1-6 per 10 cm) may be present and/or 1-6 tapes per 10 cm (1-6 per 10 cm) in width may be present. In some examples, 3-5 tapes per 10 cm in length (3-5 per 10 cm) may be present and/or 3-5 tapes per 10 cm (3-5 per 10 cm) in width may be present. For example, a mesh layer may be configured as a 4/4 per 10 cm mesh layer where 4 tapes per 10 cm in width and 4 tapes per 10 cm in length are present.

In other instances, the overall width of the mesh layer may vary from about 10 mm to about 200 cm. Where the mesh layer width is less than a desired width, different mesh layers cam be placed beside each other on a surface of the TFR layer 120 to provide a desired level of coverage across a surface of the TFR layer 120. As noted in more detail below, the mesh layer 110 may be configured with two or more different tape layers that are woven together to provide the mesh layer 110. In some instances, a basis weight of the mesh layer 110 may be about 400 grams per square meter (gsm) to about 1000 gsm, more particularly about 500 gsm to about 900 gsm or about 600-850 gsm. In some examples, the porosity of the mesh layer 110 may be less than 10%, or less than 5% or even close to 0% or 0%. Where the mesh layer 110 is configured as a woven material comprising two or more tape layers woven together, holes or openings at the intersection points of the tape layer weave may provide some overall porosity to the mesh layer 110.

In certain examples, the mesh layer 110 may comprise a fiber reinforced thermoplastic which typically is much thinner the TFR layers. For example, the layer 110 can be configured as a fiber reinforced mesh tape, which may have a uni-directional orientation of fibers or a bi-directional orientation of fibers or other fiber orientations. The thermoplastic and reinforcing fibers of the mesh layer may be any of those discussed in connection with the TFR layer, e.g., can be a polyolefin such as polypropylene, glass fibers, etc. For example, long strands of fiber glass in one direction can be held together in a mesh/tape form with polypropylene. In some examples, cut sheets of the fibers can be woven to provide a mesh layer. If desired, fibers in different directions can be woven together to provide a bi-directional fiber orientation in the mesh layer 110. In certain examples, the reinforcing fibers of the mesh layer 110 may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with a thermoplastic material, the lofting agent or both. Where a thermoplastic material is present in the mesh layer 110, the thermoplastic material of the mesh layer 110 layers may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials.

Referring now to FIG. 1B, an illustration of a multi-layer assembly comprising a thermoplastic fiber reinforced layer 120, a mesh layer 110 and a surface layer 120 is shown. As noted herein, the thermoplastic fiber reinforced (TFR) layer 120 can be directly coupled to the mesh layer 110 without any intervening components or layer, and if desired the TFR layer 120 can be directly coupled to a skin or surface layer 130. FIG. 1C shows an illustration of a multi-layer assembly comprising two thermoplastic fiber reinforced layers 120, 160 and a mesh layer 110 between the two layers 120, 160. The thermoplastic fiber reinforced layers 120, 160 can each be directly coupled to the mesh layer 110 without any intervening components or layer, e.g., without the use of an adhesive layer. The TFR layers 120, 160 can be the same or can be different, e.g., may comprise a different thickness of a basis weight. FIG. 1D shows a multi-layer assembly comprising two thermoplastic fiber reinforced layers 120, 160, a surface layer 170 and a mesh layer 110 between the layer 120, 160. The thermoplastic fiber reinforced layers 120, 160 can each be directly coupled to the mesh layer 110 without any intervening components or layer, e.g., without any adhesive layer present between the mesh layer 110 and the other layers 120, 160. If desired the TFR layer 120 can be directly coupled to the surface layer 170. FIG. 1E shows a multi-layer assembly comprising two thermoplastic fiber reinforced layers 120, 160, two surface layers 170, 180 and a mesh layer 110. If desired, the TFR layer 120 can be directly coupled to the surface layer 170, and the TFR layer 160 can be directly coupled to the surface layer 180, e.g., without any adhesive layer present between the layers.

In certain examples, the TFR layers described herein may be configured as (or used in) a glass mat thermoplastic composite (GMT) or a light weight reinforced thermoplastic (LWRT). One such LWRT is prepared by HANWHA AZDEL, Inc. and sold under the trademark SUPERLITE® material. The areal density of such a GMT or LWRT can range from about 400 grams per square meter (gsm) of the GMT or LWRT to about 4000 gsm, although the areal density may be less than 400 gsm or greater than 4000 gsm depending on the specific application needs. In some embodiments, the upper density can be less than about 4000 gsm. In certain instances, the GMT or the LWRT may comprise one or more lofting agent materials disposed in void space or pores of the GMT or the LWRT. Where two or more GMT or LWRT layers are present, the GMT or LWRT layers may be the same or may be different.

In certain examples where an LWRT is used as a surface layer, the LWRT typically includes a thermoplastic material and a plurality of reinforcing fibers which together form a web of open celled structures. For example, the TFR layer typically comprises a substantial amount of open cell structure such that void space is present in the layers. In some instances, the TFR layer 120 (and/or TFR layer 160) may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95%, 70-80%, 70-90%, 70-95%, 80-90%, 80-95% or any illustrative value within these exemplary ranges. In some instances, the TFR layer comprises a porosity or void content of greater than 0%, e.g., is not fully consolidated, up to about 95%. Unless otherwise stated, the reference to the TFR layer comprising a certain void content or porosity is based on the total volume of that TFR layer and not necessarily the total volume of the multi-layer assembly.

In certain examples, the TFR layers can be produced in the form of a GMT or LWRT sheet. In certain instances, the sheet can be generally prepared using chopped glass fibers, a thermoplastic material, optionally a lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the sheet, a thermoplastic material and reinforcing materials can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material. The resulting product may be pressed or compressed, e.g., using nip rollers or other techniques, to form a sheet which can then be coupled to a mesh layer and optionally another GMT or LWRT sheet.

In certain embodiments, the high porosity present in the TFR layer can reduce the overall weight of the layers and can permit the inclusion of agents within the void space. For example, lofting agents can reside in the void space in a non-covalently bonded manner. Application of heat or other perturbations can act to increase the volume of the non-covalently bonded lofting agent which in turn increases the overall thickness of the layer, e.g., the layer increases as the size of the lofting agent increases and/or additional air becomes trapped in the layer. If desired, flame retardants, colorants, smoke suppressants and other materials may be included in the void space of the TFR layer. Prior to lofting, the TFR layer can be compressed to reduce its overall thickness, e.g., compressed before or after the layer is coupled to one or more other layers.

In certain embodiments, the thermoplastic material of the TFR layers may comprise, at least in part, one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the TFR layer can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the TFR layer 120 can vary and illustrative amounts range from about 20% by weight to about 80% by weight, e.g., 30-70 percent by weight or 35-65 percent by weight.

In certain examples, the reinforcing fibers of the TFR layers 120, 160 may comprise glass fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the TFR layers 120, 160 may independently be from about 20% to about 90% by weight of the layer, more particularly from about 30% to about 70%, by weight of the layer. Typically, the fiber content of a multi-layer assembly comprising the TFR layer 120 varies between about 20% to about 90% by weight, more particularly about 30% by weight to about 80% by weight, e.g., about 40% to about 70% by weight of the assembly. The particular size and/or orientation of the fibers used may depend, at least in part, on the thermoplastic polymer material used and/or the desired properties of the TFR layer. Suitable additional types of fibers, fiber sizes and amounts will be readily selected by the person of ordinary skill in the art, given the benefit of this disclosure. In one non-limiting illustration, fibers dispersed within a thermoplastic material and optionally a lofting agent to provide a TFR layer can generally have a diameter of greater than about 5 microns, more particularly from about 5 microns to about 22 microns, and a length of from about 5 mm to about 200 mm; more particularly, the fiber diameter may be from about microns to about 22 microns and the fiber length may be from about 5 mm to about 75 mm.

In some embodiments, the lofting capacity of the TFR layer can be further tuned by including one or more added lofting agents. The exact type of lofting agent used in the TFR layer can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available from Kureha Corp. (Japan). In other instances, a first lofting agent with a first average particle size and a second lofting agent with a second average particle size, different from the first average particle size, may be used in the TFR layer 120. In other examples, the lofting agent may be an expandable graphite material which can also impart some flame retardancy to the multi-layer assembly.

In some configurations, the TFR layer may be a substantially halogen free or halogen free layer to meet the restrictions on hazardous substances requirements for certain applications. In other instances, one or more of the layers may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo- polycarbonates. In some instances, the thermoplastic material used in the TFR layer may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the layer), more particularly about 1 weight percent to about 13 weight percent, e.g., about 5 weight percent to about 13 weight percent. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the layer. If desired, two different substantially halogen free flame retardants may be added to one or more of the layers shown in FIGS. 1A-1E In certain instances, one or more of the layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In certain examples where two TFR layers sandwich a mesh layer (see FIG. 1C), the two TFR layers can be the same or can be different. The TFR layer 160 may comprise any of those materials discussed in connection with the TFR layer 120. In some examples, the reinforcing fibers and thermoplastic material of the TFR layers 120, 160 may be the same materials but a basis weight or thickness of the TFR layers 120, 160 can be different. In other examples, a thickness of basis weight of the TFR layers 120, 160 can be the same but the reinforcing fibers or thermoplastic material or both of the TFR layers 120, 160 can be different. In some instances, a thickness of basis weight of the TFR layers 120, 160 can be different and the reinforcing fibers or thermoplastic material or both of the TFR layers 120, 160 can also be different.

In certain embodiments, the surface layers 130, 170, 180 each can independently take numerous forms and is typically different from the TFR and mesh layers. In some embodiments, the layers 130, 170 and 180 each may take the form of a skin. The skin 130, 170 and 180 each may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skin 130, 170 and 180 each may comprise a limiting oxygen index greater than about 22, as measured per ISO 4589 dated 1996. Where a thermoplastic film is present as (or as part of) the skin 130, 170 or 180, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin 130, 170 or 180, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin 130, 170 or 180, the coating may comprise at least one of unsaturated polyurethanes, vinyl esters, phenolics and epoxies. Where an inorganic coating is present as (or as part of) the skin 130, 170 or 180, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin 130, 170 or 180, the non-woven fabric may comprise a thermoplastic material, a thermal setting binder, inorganic fibers, metal fibers, metallized inorganic fibers and metallized synthetic fibers. If desired, the skin may also comprise a lofting agent as well.

In certain instances, one or more of the layers 130, 170 and 180 may be configured as a decorative layer. The decorative layer may be formed, e.g., from a thermoplastic film of polyvinyl chloride, polyolefins, thermoplastic polyesters, thermoplastic elastomers, or the like. The decorative layer 130, 170 or 180 may comprise a carpet, rubber or other aesthetic covering. The decorative layer 130, 170 or 180 may also be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer may also be produced using spunbond, thermal bonded, spun lace, melt-blown, wet-laid, and/or dry-laid processes.

In certain examples, each of the layers of the multi-layer assembly can be separately produced and then combined together to form the multi-layer assembly. For example, each of the layers may be separately produced in a wet laid or other process and then combined together to provide the multi-layer assembly. In producing the various fiber reinforced thermoplastic layers described herein, it may be desirable to use a wet-laid process. For example, a liquid or fluid medium comprising dispersed material, e.g., thermoplastic materials, fibers and optionally lofting agent material optionally with any one or more additives described herein (e.g., other lofting agents or flame retardant agents), may be stirred or agitated in the presence of a gas, e.g., air or other gas. The dispersion may then be laid onto a support, e.g., a wire screen or other support material. The stirred dispersion may comprise one or more active agents, e.g., anionic, cationic, or non-ionic such as, for example, those sold under the name ACE liquid by Industrial Soaps Ltd., that sold as TEXOFOR® FN 15 material, by Glover Chemicals Ltd., and those sold as AMINE Fb 19 material by Float-Ore Ltd. These agents can assist in dispersal of air in the liquid dispersion. The components can be added to a mixing tank, flotation cell or other suitable devices in the presence of air to provide the dispersion. While an aqueous dispersion is desirably used, one or more non-aqueous fluids may also be present to assist in dispersion, alter the viscosity of the fluid or otherwise impart a desired physical or chemical property to the dispersion or the layer.

In certain instances, after the dispersion has been mixed for a sufficient period, the fluid with the suspended materials can be disposed onto a screen, moving wire or other suitable support structure to provide a web of laid down material. Suction or reduced pressure may be provided to the web to remove any liquid from laid down material to leave behind the thermoplastic material, lofting agent and any other materials that are present, e.g., fibers, additives, etc. The resulting web can be dried, consolidated, pressed, lofted, laminated, sized or otherwise processed further to provide a desired layer or article. In some instances, an additive or additional lofting agent material can be added to the web prior to drying, consolidation, pressing, lofting, laminating, sizing or other further processing to provide a desired layer or article. In other instances, the lofting agent may be added to the web subsequent to drying, consolidation, pressing, lofting, laminating, sizing or other further processing to provide a desired layer or article. While wet laid processes may be used, depending on the nature of the thermoplastic material, the lofting agent material and other materials present, it may be desirable to instead use an air laid process, a dry blend process, a carding and needle process, or other known process that are employed for making non-woven products.

In some configurations, the fiber reinforced thermoplastic layers described herein can be produced by combining a thermoplastic material, fibers, and an optional microsphere lofting agent in the presence of a surfactant in an aqueous solution or foam. The combined components can be mixed or agitated for a sufficient time to disperse the various materials and provide a substantially homogeneous aqueous mixture of the materials. The dispersed mixture is then laid down on any suitable support structure, for example, a wire mesh or other mesh or support having a desired porosity. Water can then be evacuated through the wire mesh forming a web. The web is dried and heated above the softening temperature of the thermoplastic powder. The web is then cooled and pressed to a predetermined thickness to produce a composite sheet having a void content of between about 1 percent to about 95 percent. In an alternate embodiment, the aqueous foam also includes a binder material. In some configurations, after the web is heated above the softening temperature of the thermoplastic powder, an adhesive layer comprising a thermoplastic polymer and a thermosetting material can then be disposed on the web.

In certain examples, one or more of the fiber reinforced thermoplastic layers can be produced in the form of a GMT. In certain instances, the GMT can be generally prepared using chopped glass fibers, a thermoplastic material, lofting agent and an optional thermoplastic polymer film or films and/or woven or non-woven fabrics made with glass fibers or thermoplastic resin fibers such as, for example, polypropylene (PP), polybutylene terephthalate (PBT), polyethylene terephthalate (PET), polycarbonate (PC), a blend of PC/PBT, or a blend of PC/PET. In some embodiments, a PP, a PBT, a PET, a PC/PET blend or a PC/PBT blend can be used as a resin. To produce the glass mat, a thermoplastic material, reinforcing materials, lofting agent and/or other additives can be added or metered into a dispersing foam contained in an open top mixing tank fitted with an impeller. Without wishing to be bound by any particular theory, the presence of trapped pockets of air of the foam can assist in dispersing the glass fibers, the thermoplastic material and the lofting agent. In some examples, the dispersed mixture of glass and resin can be pumped to a head-box located above a wire section of a paper machine via a distribution manifold. The foam, not the glass fiber, lofting agent or thermoplastic, can then be removed as the dispersed mixture is provided to a moving wire screen using a vacuum, continuously producing a uniform, fibrous wet web. The wet web can be passed through a dryer at a suitable temperature to reduce moisture content and to melt or soften the thermoplastic material. When the hot web exits the dryer, a surface layer such as, for example, an adhesive layer comprising a thermoplastic polymer and a thermosetting material may be laid onto the web by passing the web of glass fiber, lofting agent, thermoplastic material and film through the nip of a set of heated rollers followed by spraying of the adhesive onto the surface of the web. If desired, additional layers such as, for example, a non-woven and/or woven fabric layer or skin layer may also be attached to one side or to both sides of the web to facilitate ease of handling the glass fiber-reinforced mat. The composite can then be passed through tension rolls and continuously cut (guillotined) into the desired size for later forming into an end product article. Further information concerning the preparation of such GMT composites, including suitable materials and processing conditions used in forming such composites, are described, for example, in U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US2005/0228108, US 2005/0217932, US 2005/0215698, US 2005/0164023, and US 2005/0161865.

In some instances, each of the fiber reinforced thermoplastic layers may be formed separately as a sheet which is then used to provide a multi-layer article or multi-layer assembly. For example, a wet laid process can be used to produce a first fiber reinforced thermoplastic sheet with a low lofting capacity. A wet laid process can also be used to produce a second fiber reinforced thermoplastic sheet with a higher lofting capacity than the first sheet. Each sheet may be processed prior to coupling to each other through a mesh layer. For example, each sheet may be compressed to provide for a desired thickness. Any one, two or more of the produced fiber reinforced thermoplastic sheets can be coupled to a mesh layer to provide a multi-layer assembly as described herein. While the coupling process may vary, in some instances, one first fiber reinforced thermoplastic sheet is heated to a temperature where the thermoplastic component softens. The heated fiber reinforced thermoplastic sheet can then be coupled to a mesh layer. If desired, a second fiber reinforced thermoplastic sheet, which may be the same or different from the first fiber reinforced thermoplastic, is then disposed on the other surface of the mesh layer. Optional additional heating is applied to soften the disposed second fiber reinforced thermoplastic sheet. The coupled two or three layers can then be compressed or further processed. For example, pressure and/or temperature may be applied using processes such as molding, thermoforming, etc. to assist in coupling the sheets to each other and/or to impart a desired shape to the article. In some embodiments, the assembly can be molded into a desired shape of an automotive interior vehicle part, a building product or other final articles. For example, the articles described herein can be processed into a desired configuration or shape using suitable processes including, but not limited to, molding, thermoforming, drawing or other forming processes. In some instances, such processes are used to impart a desired configuration, thickness and/or to loft the various layers of the article.

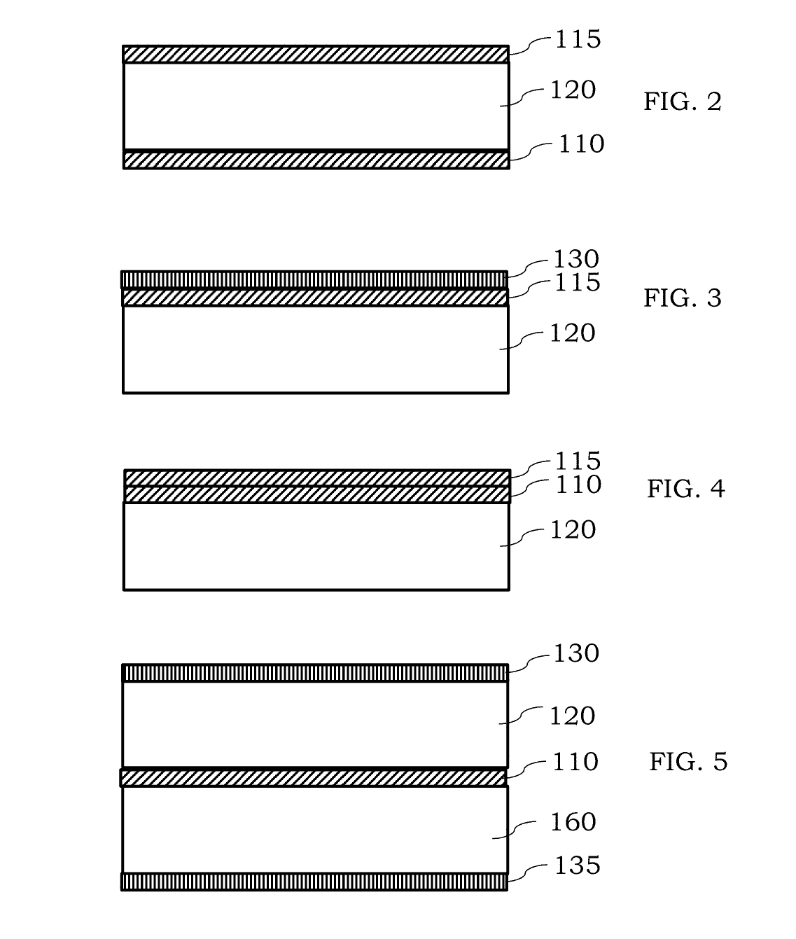

Referring now to FIG. 2, an illustration of a multi-layer assembly comprising a thermoplastic fiber reinforced layer 120 and two mesh layers 110, 115 are shown. The mesh layers 110, 115 can be the same or can be different. In some examples, the materials of the mesh layers 110, 115 are the same but a basis weight or thickness of the mesh layers 110, 115 is different. In other instances, the materials of the mesh layers 110, 115 are different but a basis weight or thickness of the mesh layers 110, 115 is the same. In additional configurations, the materials of the mesh layers 110, 115 are different and a basis weight or thickness of the mesh layers 110, 115 is also different. If desired, one or more additional mesh layers can be coupled to the mesh layers 110, 115 to provide a mesh layer stack on one surface of the TFR layer 120. The stacked mesh layers can be coupled to each other prior to adding the stacked meshed layers to the TFR layer 120 or may be coupled to each other after they are added to the TFR layer 120. If desired, no adhesive or other materials may be present between the TFR layer and the mesh layers 110, 115. In some instances, an adhesive layer can be present between one of the mesh layers 110, 115 and the TFR layer 120. In additional instances, an adhesive layer can be present between each of the mesh layers 110, 115 and the TFR layer 120. In some instances, the mesh layers 110, 115 need not span across an entire surface of the TFR layer 120 but may be present on one side or area of the TFR layer 120 as desired. If desired, an additional TFR layer (not shown) can be coupled to the mesh layer 115 or mesh layer 110 to provide a stack of TFR layers separated by a mesh layer. In addition, a decorative layer, skin or other layer could also be coupled to the mesh layer 115 or the mesh layer 110 as desired.

In certain examples and referring to FIG. 3, a multi-layer assembly is shown that comprise a mesh layer 115 coupled to a TFR layer 120 at one surface and coupled to a skin layer 130 at an opposite surface. While not shown, another mesh layer, a TFR layer, a decorative layer or skin layer can be coupled to the TFR layer 120 at an opposite surface from where the mesh layer 115 is coupled. In some instances, the skin 130 may be a fabric, scrim or other materials described above in reference to the skin 130. The mesh layer 110 may be any mesh layer described in reference to mesh layer 110. In some examples, the mesh layer 115 and the skin 130 can be coupled to each other prior to coupling to the TFR layer 120. In other instances, the mesh layer 115 may first be coupled to the TFR layer 120 and then the skin 130 can be added to a surface of the mesh layer 115. In some embodiments, the mesh layer 115 can be coupled to the TFR layer 120 without any other layer present between layers 115, 120, e.g., without the use of an adhesive layer. Similarly, the skin 130 can be coupled to the mesh layer 115 without any other layer present between layers 115, 130, e.g., without the use of an adhesive layer. If desired, however, an adhesive or other material may be present between any of the layers shown in FIG. 3.

In certain configurations and referring to FIG. 4, a multi-layer assembly is shown that comprises a mesh layer 110 coupled to a TFR layer 120 at one surface and to another mesh layer 115 at a second surface. The mesh layers 110, 115 can be the same or can be different. In some examples, the materials of the mesh layers 110, 115 are the same but a basis weight or thickness of the mesh layers 110, 115 is different. In other instances, the materials of the mesh layers 110, 115 are different but a basis weight or thickness of the mesh layers 110, 115 is the same. In additional configurations, the materials of the mesh layers 110, 115 are different and a basis weight or thickness of the mesh layers 110, 115 is also different. If desired, one or more additional mesh layers can be coupled to the mesh layers 110, 115 to provide a mesh layer stack on one surface of the TFR layer 120. Alternatively, another mesh layer or other layer can be coupled to an opposite surface of the TFR layer 120. The stacked mesh layers 110, 115 can be coupled to each other prior to adding the stacked meshed layers to the TFR layer 120 or may be coupled to each other after they are added to the TFR layer 120. If desired, no adhesive or other materials may be present between the TFR layer and the mesh layers 110, 115. In some instances, an adhesive layer can be present between the mesh layer 110 and the TFR layer 120. In additional instances, an adhesive layer can be present between each of the mesh layers 110 and 115. In some instances, the mesh layers 110, 115 need not span across an entire surface of the TFR layer 120 but may be present on one area of the TFR layer 120 as desired. If desired, an additional TFR layer (not shown) can be coupled to the mesh layer 115 to provide a stack of TFR layers separated by the two mesh layers 110, 115. In addition, a decorative layer, skin or other layer could also be coupled to the mesh layer 115 as desired.

In certain examples and referring to FIG. 5, a multi-layer assembly comprising TFR layers 120, 160 separated by a mesh layer 110 is shown. A skin 130 is present on an opposite surface of the TFR layer 120, and a skin 135 is present on an opposite surface of the TFR layer 160. The TFR layers 120, 160 can each be directly coupled to the mesh layer 110 without any intervening components or layer, e.g., without the use of an adhesive layer. The TFR layers 120, 160 can be the same or can be different, e.g., may comprise a different thickness of a basis weight. Similarly, the skin layers 130, 135 can be the same or different and can be coupled to the TFR layers 120, 160, respectively, with or without the use of an adhesive layer. In some instances, the skin layers 130, 135 may comprise the same materials but may comprise a different thickness or basis weight. In other instances, the skin layers 130, 135 may comprise different same materials but may comprise a same basis weight or thickness. In additional examples, the skin layers 130, 135 may comprise different same materials and may also comprise a different basis weight or thickness. The skins 130, 135 each may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating. In other instances, the skins 130, 135 each may independently comprise a limiting oxygen index greater than about 22, as measured per ISO 4589 dated 1996. Where a thermoplastic film is present as (or as part of) the skins 130, 135, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skins 130, 135, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skins 130, 135, the coating may comprise at least one of unsaturated polyurethanes, vinyl esters, phenolics and epoxies. Where an inorganic coating is present as (or as part of) the skins 130, 135, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skins 130, 135, the non-woven fabric may comprise a thermoplastic material, a thermal setting binder, inorganic fibers, metal fibers, metallized inorganic fibers and metallized synthetic fibers. If desired, the skins 130, 135 may also comprise a lofting agent as well. In some examples, one or both of the skins 130, 135 may take the form of a decorative layer. The decorative layer may be formed, e.g., from a thermoplastic film of polyvinyl chloride, polyolefins, thermoplastic polyesters, thermoplastic elastomers, or the like. The decorative layers 130, 135 may independently comprise a carpet, rubber or other aesthetic covering. The decorative layers 130, 135 may also independently be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layers 130, 135 may independently be produced using spunbond, thermal bonded, spun lace, melt-blown, wet-laid, and/or dry-laid processes.

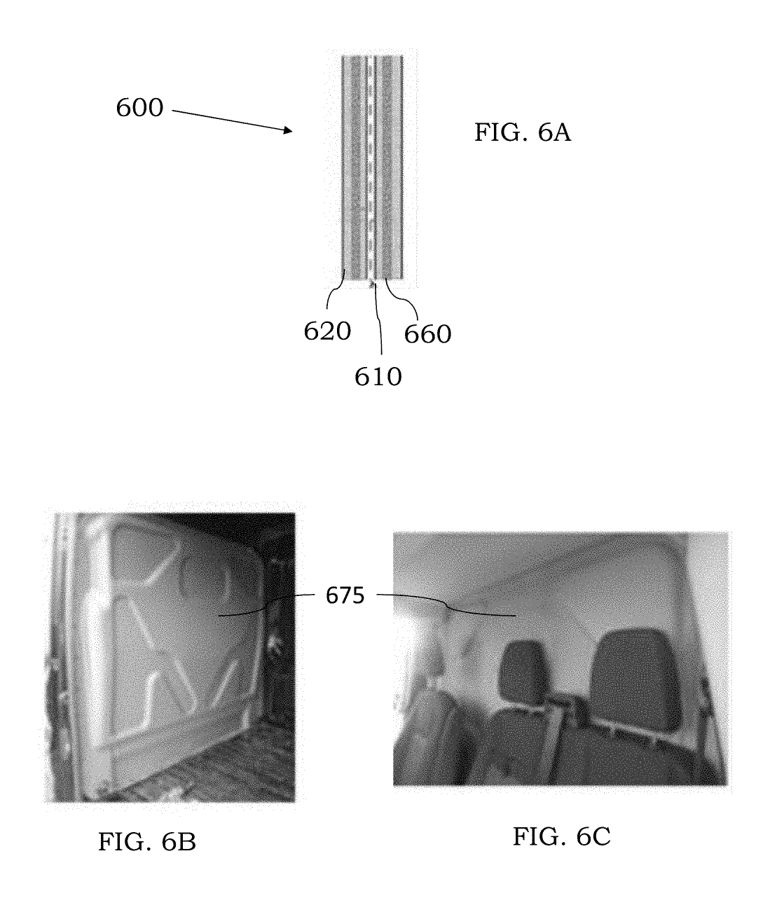

In some examples, the multi-layer assemblies described herein can be used as many different articles including divider panels, ceiling panels, building substrates (e.g., walls, flooring, etc.), automotive vehicle walls or dividers, recreational vehicle panels, recreational vehicle ceilings, recreational vehicle floors, recreational vehicle storage compartments or doors and the like. Referring to FIG. 6A, one illustration of a multi-layer assembly 600 is shown that comprises two TFR layers 620, 660 separated by a mesh layer 610. Each of the TFR layers 620, 660 may independently be configured similar to the TFR layer 120 as described herein. In some examples, each of the TFR layers is configured as a LWRT sheet comprising polypropylene and glass fibers and comprising a basis weight of about 800 gsm-1000 gsm. The mesh layer 610 may be configured similar to the mesh layer 110. In one instance, the mesh layer 610 may comprise glass fibers and polypropylene and comprises a basis weight of about 500-1000 gsm. The multi-layer assembly can be used, for example, as a bulk head wall to separate a cargo area in a vehicle from a passenger area. Referring to FIG. 6B and 6C, a bulk head wall 675 is shown that comprises the multi-layer assembly 600. The overall weight of the bulk head wall 675 can be substantially less than conventional steel bulk head panels, e.g., the bulk head wall weight can be 25%, 30% or 40% less when a multi-layer assembly is used as compared to the weight when steel is present. The bulk head wall need not be continuous or solid from one side of the vehicle to another. For example, a passageway may exist to permit the occupants in the passenger area to move into the cargo area. Such passageways may be particularly useful where the bulk head wall is used in commercial trucks that comprise a sleeping area separate from an area where the driver sits to drive the vehicle.

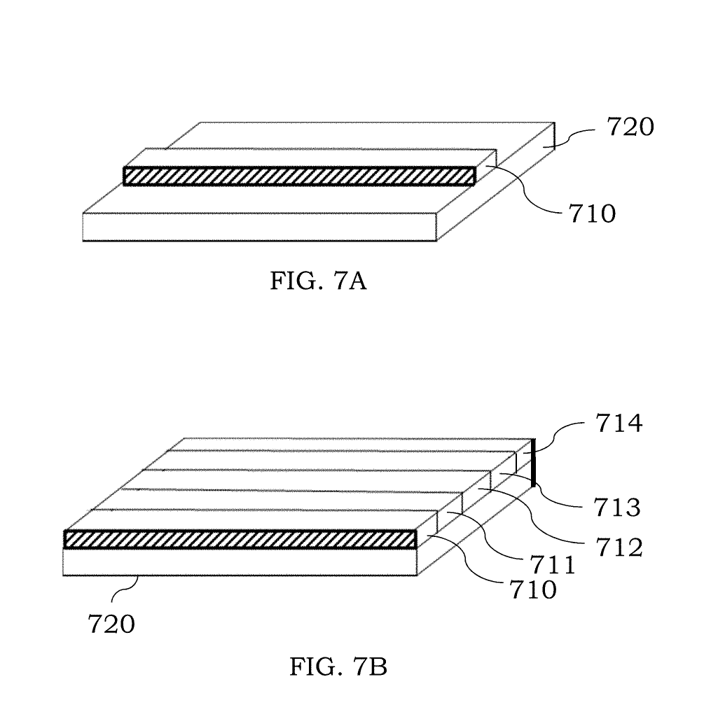

In certain embodiments and referring to FIG. 7A, a multi-layer assembly 700 may comprise a fiber reinforced thermoplastic layer 720 and a mesh layer 710 disposed on some portion of a first surface of the first TFR layer 720. The mesh layer 710 can be configured similar to the mesh layer 110, and the TFR layer 720 can be configured similar to TFR layer 120. In FIG. 7A, the mesh layer 710 is configured as a tape layer that is positioned on top of the TFR layer 720. If desired, additional tape layers 711-714 (see FIG. 7B) can be placed adjacent to the tape layer 710 so that tape layers span across the entire first surface of the TFR layer 720. The additional tape layers 711-714 need not be parallel with the tape layer 710 but may instead be placed in a cross-direction or in other directions. In addition, the additional tape layers 711-714 need not have the same composition as the tape layer 710 or as each other. Further, the tape layers 710-714 may have different basis weights, fibers, thermoplastic materials, thicknesses, etc. as desired.

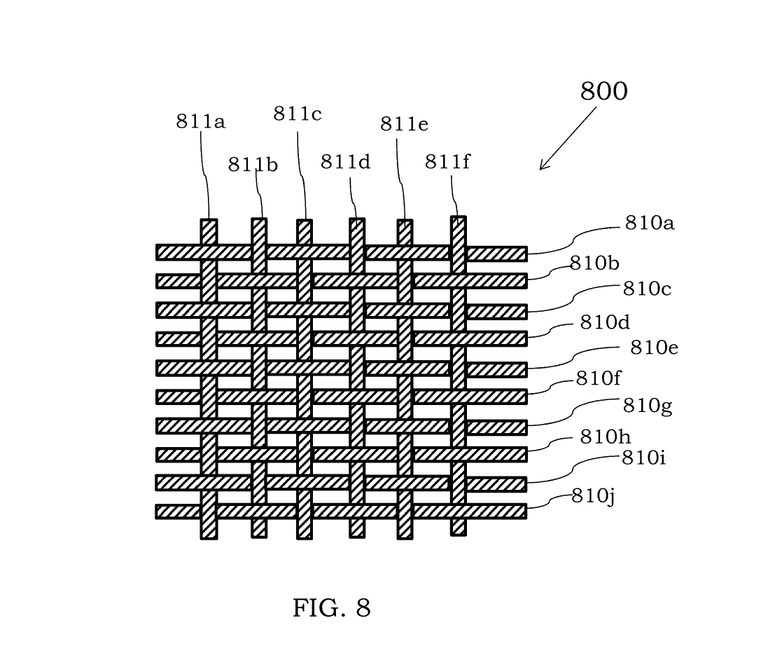

In some examples, two or more tape layers may be woven together prior to placement on a surface of a TFR layer. Referring to FIG. 8, a mesh layer 800 is shown comprising a plurality of tape layers 810-810j that have been woven with tape layers 811a-811f. The exact number of different tape layers present in the mesh layer 800 may vary from about 1-10 tape layers per 10 cm in the width direction and about 1-10 tape layers per 10 cm in the length direction. Fewer or more tape layers can be present in either direction, however, if desired. The overall width and length of the mesh layer 800 may vary from about 10 mm wide to about 200 cm wide, and about 10 mm long to about 400 cm long. If desired, the dimensions of the mesh layer 800 can be sized such that an entire mesh layer can cover substantially all of a surface of a TFR layer. Alternatively, two or more of mesh layers 800 can be disposed on a surface of a TFR layer so the entire surface of the TFR layer is covered. The tape layers 810a-810j and 811a-811f may independently be the same or may be different as desired. In some examples, each of the tape layers 810a-810j comprises substantially the same composition, and each of the tape layers 811a-811j comprises substantially the same composition, which may be different than the composition of tape layers 811a-811j. The basis weight of each of the tape layers may vary from about 50 gsm to about 1000 gsm. In some examples, the entire mesh layer 800 may comprise a basis weight of about 100 gsm to about 1000 gsm. As shown in FIG. 8, the mesh layer may have some porosity provided by the openings formed from the weaving of the tape layers together, even though each tape layer itself may be substantially non-porous or porous as desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A multi-layer assembly comprising:
a mesh layer comprising reinforcing fibers held in place by a thermoplastic material; and
a first fiber reinforced thermoplastic layer disposed on a first surface of mesh layer, the first fiber reinforced thermoplastic layer comprising a web of open celled structures formed by a plurality of reinforcing materials bonded together with a thermoplastic material.

2. The multi-layer assembly of claim 1, wherein the first reinforced thermoplastic layer is directly coupled to the mesh layer without any intervening layers or materials.

3. The multi-layer assembly of claim 1, further comprising a second reinforced thermoplastic layer disposed on a second surface of mesh layer, the second fiber reinforced thermoplastic layer comprising a web of open celled structures formed by a plurality of reinforcing materials bonded together with a thermoplastic material.

4. The multi-layer assembly of claim 3, wherein the second reinforced thermoplastic layer is directly coupled to the mesh layer without any intervening layers or materials.

5. The multi-layer assembly of claim 4, further comprising a first skin layer disposed on the first reinforced thermoplastic layer.

6. The multi-layer assembly of claim 5, further comprising a second skin layer disposed on the second reinforced thermoplastic layer.

7. The multi-layer assembly of claim 4, wherein the mesh layer comprises glass fibers and polypropylene and is configured as a woven tape layer, and wherein the first fiber reinforced thermoplastic layer and the second fiber reinforced thermoplastic layer each comprises polypropylene and glass fibers and a basis weight of about 800 gsm to about 1000 gsm.

8. The multi-layer assembly of claim 7, further comprising a decorative layer coupled to one of the first fiber reinforced thermoplastic layer and the second fiber reinforced thermoplastic layer.

9. The multi-layer assembly of claim 8, wherein the decorative layer comprises a foam bonded to a fabric.

10. The multi-layer assembly of claim 1, in which the thermoplastic material of the first fiber reinforced thermoplastic layer comprises one or more of polyethylene, polypropylene, polystyrene, acrylonitrylstyrene, butadiene, polyethyleneterephthalate, polybutyleneterephthalate, polybutylenetetrachlorate, polyvinyl chloride, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, a poly(1,4 phenylene) compound, a high heat polycarbonate, high temperature nylon, silicones, or blends of these materials with each other.

11. The multi-layer assembly of claim 10, in which the reinforcing fibers of the first fiber reinforced thermoplastic layer comprise one or more of glass fibers, aramid fibers, graphite fibers, carbon fibers, inorganic mineral fibers, metal fibers, metalized synthetic fibers, and metallized inorganic fibers, fibers or combinations thereof.

12. The multi-layer assembly of claim 1, further comprising a skin coupled to a surface of the first fiber reinforced thermoplastic layer.

13. The multi-layer assembly of claim 12, in which the skin is selected from the group consisting of a thermoplastic film, an elastomeric film, a frim, a scrim, a foil, a woven fabric, a non-woven fabric, a fiber scrim, an inorganic coating, an organic coating, a thermoplastic coating and a thermoset coating.

14. The multi-layer assembly of claim 12, in which the first fiber reinforced thermoplastic layer further comprises a lofting agent.

15. The multi-layer assembly of claim 1, further comprising a decorative layer coupled to the first fiber reinforced thermoplastic layer.

16. A multi-layer assembly comprising:
a mesh layer comprising a first tape layer and a second tape layer, wherein the first and second tape layers are present in a woven arrangement, and wherein each of the first tape layer and the second tape layer comprises reinforcing fibers held in place by a thermoplastic material;
a first fiber reinforced thermoplastic layer disposed on a first surface of mesh layer, the first fiber reinforced thermoplastic layer comprising a web of open celled structures formed by a plurality of reinforcing materials bonded together with a thermoplastic material; and
a second fiber reinforced thermoplastic layer disposed on a second surface of mesh layer, the second fiber reinforced thermoplastic layer comprising a web of open celled structures formed by a plurality of reinforcing materials bonded together with a thermoplastic material, wherein each of the first fiber reinforced thermoplastic layer and the second fiber reinforced thermoplastic layer are directly coupled to the mesh layer without any intervening layer or material.

17. The multi-layer assembly of claim 16, further comprising a second mesh layer disposed on a surface of the second fiber reinforced thermoplastic layer.

18. The multi-layer assembly of claim 16, wherein the thermoplastic material of the first fiber reinforced layer is different than the thermoplastic material of the second fiber reinforced layer.

19. The multi-layer assembly of claim 16, wherein the thermoplastic material of the first fiber reinforced layer comprises a common material as the thermoplastic material of the second fiber reinforced layer.

20. The multi-layer assembly of claim 19, wherein the thermoplastic material of the first fiber reinforced layer and the thermoplastic material of the second fiber reinforced layer each comprises polypropylene.

21-60. (canceled)
